(19) United States
(12) Patent Application Publication
(10) Pub. No.: US 2025/0008943 A1
(43) Pub. Date: Jan. 9, 2025

(54) COLLAPSIBLE BUGLE TUBE FOR GAME CALL

(71) Applicant: KYVEN LLC, West Jordan, UT (US)

(72) Inventors: Kyle T. Bradshaw, West Jordan, UT (US); Steven Bradshaw, Riverton, UT (US)

(21) Appl. No.: 18/764,127

(22) Filed: Jul. 3, 2024

Related U.S. Application Data
(60) Provisional application No. 63/511,872, filed on Jul. 4, 2023.
(60) Provisional application No. 63/515,342, filed on Jul. 25, 2023.

(51) Int. Cl. A01M 31/00

(52) U.S. Cl. CPC A01M 31/004

(57) ABSTRACT

A collapsible bugle tube for game calling is a lightweight, compact, and adjustable tool for producing realistic game calls. The bugle tube may be transformed from one or more in-use configurations into reduced-size transport configuration. The collapsibility, and adaptability for cooperation with various mouthpieces, ensure the call can produce a range of sounds that are particularly beneficial for attracting elk. The bugle tube includes tube portions that telescope into the one or more in-use configurations. An endcap is used to create back-pressure in the bugle tube for resonant and realistic game call sounds. The endcap is also used for securing all of the tube portions in the transport configuration, or for securing to the endcap selected but not all of the tube portions to allow extension of various of the tube portions to create multiple in-use configurations.

This application claims benefit of Provisional Application 63/511,872 filed Jul. 4, 2023, and Provisional Application 63/515,342 filed Jul. 25, 2023, the entire disclosures of which two applications are incorporated herein by this reference.

### FIELD OF THE INVENTION

The present invention relates to a collapsible bugle tube game call. The collapsible bugle tube game call enables hunters, sportsmen, or recreationists, to produce realistic game calls while offering portability, compactness, adjustability, and modularity, for ease of transportation and use during hunting and recreation expeditions. Certain embodiments of the bugle tube are modular, to allow for interchangeable parts that can be customized for the users desired material preferences and for optimizing the best and most realistic elk sounds.

### BACKGROUND OF THE INVENTION

Game hunting requires skilled use of calls to attract animals for better hunting opportunities. In the case of elk hunting, many traditional elk calls are difficult to use or have inherent structural drawbacks that tend to produce less than realistic and effective sounds. Traditional elk calls that include a bugle can be cumbersome to carry and may not provide the portability, adjustability, modularity, or sound-quality required for various hunting scenarios. The present collapsible bugle tube elk call addresses these issues and offers a novel solution for hunters to carry an effective and versatile elk call that can produce realistic and effective sounds.

### SUMMARY OF THE INVENTION

The collapsible bugle tube game call provides hunters or other recreationists with a lightweight, compact, and adjustable tool for producing realistic game calls. The collapsible bugle tube is adapted to be transformed from one or more in-use configurations into a more convenient transport configuration, which is reduced in size compared to the in-use configuration for transportation and/or storage. In certain embodiments, these features, plus adaptability for cooperation with various mouthpieces and/or modularity for cooperation with components of various materials, ensure the call can produce a range of sounds that are particularly beneficial for attracting elk.

In certain embodiments, the collapsible bugle tube game call comprises multiple tube portions that telescope, or otherwise slide longitudinally, relative to each other, to adjust the bugle tube to having multiple lengths and multiple air passage maximum diameters, and, therefore, to multiple in-use configurations. The bugle tube is adapted so that, upon, or as part of, adjustment of the portions to said multiple in-use configurations, the portions are latched or otherwise temporarily secured together so that use of the bugle tube may conveniently commence with little or no chance for unwanted or accidental sliding or slippage to another configuration. In certain embodiments, latching/securement is accomplished threaded or other twist-lock connections, for example, a bayonet connection or other tab-and-recess system that allows the tube portions to slide generally into place and then to be latched/locked in place by a twist or other relative rotation of the tube portions being connected. In certain embodiments, during extension until said latching/securement is done, the tube portions easily slide longitudinally relative to each other, for example, with some space between the tube portions' outer walls so as to be loose relative to each other, with little or no friction or interference with each other.

In certain embodiments, the bugle tube comprises an endcap that is adapted to connect to at least one of the bugle tube portions, preferably to at least the large-diameter bugle tube portion that is in the lower or “distal” position during use of the bugle tube. The lower/distal bugle tube portion may also be called a “resonator chamber” or “bell” due to its harmonic content contributions, or the “outer shell” due to it preferably being the outer shell/casing when the bugle tube is in the collapsed or “fully retracted” configuration. The endcap partially closes the distal end of said bell portion for creating air backpressure inside the bugle tube, which is important for creating the pitch, volume, and quality of sounds from the bugle tube that are complex and natural sounding, for example, sounds that may be called “three-dimensional” and realistic.

In certain embodiments, the end cap is adapted to connect to various of the bugle tube portions so that the bugle tube may easily be held in each of said multiple in-use configurations, to produce different sounds from each configuration, and also easily held in the fully collapsed transport configuration for travel and storage. For example, in certain embodiments of a fully extended in-use configuration, only the outer shell/bell is connected to the endcap, while in certain embodiments of a partially extended in-use or “mid-point” configuration, both the outer shell/bell and the central tube portion are connected to the end-cap. Also, for example, in certain embodiments of the collapsed transport configuration, all the outer shell/bell, the central tube portion, and the mouthpiece tube portion are connected to the end-cap. In certain embodiments. In preferred embodiments, the latching/securement system(s) employed on the endcap to connect to one or more of the tube portions may be the same or similar to the threaded or other twist-lock connections that connect the tube portions together.

In certain embodiments, the latching/securement systems between the tube portions and the tube portions and the end-cap may be disconnected to separate the bugle tube portions and the end-cap, for example, for example, for cleaning, replacement, or substitution of a piece of the bugle tube, including but not limited to changing out the mouthpiece to an alternative mouthpiece style. In certain embodiments, each part of the bugle tube is modular, so that any tube portion or endcap can be interchangeable with other versions, for example, versions that are made of other materials comprised of different or various polymers, carbon fiber, resins, acrylic, nylons, and/or aluminum or other metals for adapting the bugle tube to users' desired configurations. In certain embodiments, the bugle tube portions cannot be separated when the endcap is in place. However, in preferred embodiments, upon detachment of the endcap from the tube portion(s) to which it is attached during use or storage of the bugle, the bugle tube portions may be separated from each other for cleaning, replacement, substitution, or storage of the individual parts.

### BRIEF DESCRIPTION OF THE DRAWINGS

FIG. 1 is a front perspective view of one embodiment of the invented game call bugle tube, in a fully retracted or “collapsed” transport configuration.

FIG. 2 is a rear side view of the embodiment of FIG. 1.

FIG. 3 is a front side view of the embodiment of FIG. 1.

FIG. 4 is a top end view of the embodiment of FIG. 1.

FIG. 5 is a bottom end view of the embodiment of FIG. 1.

FIG. 6 is a front side view of the embodiment of FIG. 1, as in FIG. 3, except that a cross-sectional line FIG. 7-FIG. 7 is added.

FIG. 7 is a longitudinal cross-sectional of the embodiment of FIG. 1, viewed along the line FIG. 7-FIG. 7 in FIG. 6.

FIG. 7A is the longitudinal cross-sectional view shown in FIG. 7, except with a lower area circled for enlargement in FIG. 8.

FIG. 8 is a detail view of the area circled in FIG. 7A.

FIG. 9 is a side perspective view of the embodiment of FIG. 1, extended to a “fully extended” or “full-length” configuration for use as a game call.

FIG. 10 is a top end view of the fully extended configuration of the bugle tube as shown in FIG. 9.

FIG. 11 is a bottom end view of the fully extended configuration of the bugle tube shown as shown in FIG. 9.

FIG. 12 is a rear side view of the fully extended bugle tube of FIG. 9.

FIG. 13 is a front side view of the fully extended bugle tube of FIG. 9.

FIG. 14 is a longitudinal cross-sectional view of the fully-extended bugle tube of FIG. 9, viewed along the FIG. 14-FIG. 14 line in FIG. 13.

FIG. 15 is a front side view of the mouthpiece tube portion of the game call bugle tube embodiment of FIGS. 1-14, with dashed lines showing interior walls and portions of the threading that extends around the opposite, rear side of the mouthpiece tube portion.

FIG. 16 is a detail of the area of the mouthpiece tube portion that is circled in FIG. 15, without the dashed lines.

FIG. 17 is a front side view of the mouthpiece tube portion of FIG. 15, with dashed lines removed, including a cross-section line FIG. 20-FIG. 20.

FIG. 18 is a top end view of the mouthpiece tube portion of FIGS. 15-17.

FIG. 19 is a bottom end view of the mouthpiece tube portion of FIGS. 15-17.

FIG. 20 is a longitudinal cross-sectional view of the mouthpiece tube portion as viewed along line FIG. 20-FIG. 20 in FIG. 17.

FIG. 21 is a side perspective view of the central tube portion or “main body” of the game call bugle tube embodiment of FIGS. 1-14.

FIG. 22 is a top end view of the central tube portion of FIG. 21.

FIG. 23 is a bottom end view of the central tube portion of FIG. 21.

FIG. 24 is a side view of the central tube portion of FIG. 21, including a cross-section line FIG. 25-FIG. 25.

FIG. 25 is longitudinal cross-section view of the central tube portion viewed along the line FIG. 25-FIG. 25 in FIG. 24.

FIG. 26 is a top perspective view of the outer shell or “bell” tube portion of the game call bugle tube embodiment of FIGS. 1-14, which also may be called the “outer” tube portion (FIGS. 1-8) or the “lower” tube portion (FIGS. 9-14).

FIG. 27 is a longitudinal cross-sectional view of the bell tube portion of FIG. 26, viewed along the line FIG. 27-FIG. 27 in FIG. 26.

FIG. 28 is a rear view of the bell tube portion of FIG. 26.

FIG. 29 is the bottom end view of the bell tube portion of FIG. 28.

FIG. 30 is a front view of the bell tube portion of FIG. 28.

FIG. 31 is a top end view of the bell tube portion of FIG. 30.

FIG. 32 is a top perspective view of the endcap of the embodiment of FIGS. 1-14.

FIG. 33 is a bottom perspective view of the endcap of the embodiment of FIGS. 1-14.

FIG. 34 is a top view of the endcap of the embodiment of FIGS. 1-14.

FIG. 35 is a bottom view of the endcap of the embodiment of FIGS. 1-14.

FIG. 36 is a side view (or “edge view”) of the endcap of the embodiment of FIGS. 1-14.

FIG. 37 is a side view (or “edge view”) of the endcap of the embodiment of FIGS. 1-14.

FIG. 38 is a cross-sectional view of the endcap of the embodiment of FIGS. 1-14.

FIG. 39 is a side view of the embodiment of FIG. 1, extended to a “partially extended” or “mid-point” or “mid-length” configuration for use as a game call that will tend to product different sounds compared to the fully extended configuration.

FIG. 40 is a rear view of the partially extended in-use configuration shown in FIG. 39.

FIG. 41 is a longitudinal cross-section of the partially-extended configuration of FIG. 39, viewed along the line FIG. 41-FIG. 41 in FIG. 40.

FIG. 42 is a side view of an alternative embodiment of the mouthpiece tube portion of the game call bugle tube of FIGS. 1-14.

### DETAILED DESCRIPTION OF CERTAIN EMBODIMENTS

Referring to the Figures, there are shown some, but not the only, embodiments of the collapsible bugle tube game call. In many embodiments, the collapsible bugle tube is well-adapted for calling elk in that it is capable of creating a wide range of sounds that mimic male elk, or even female elk in certain embodiments or methods of use. The bugle tube allows for versatile calling techniques to produce high-quality, life-like sounds, while featuring elements that result in mechanical and performance benefits enhancing the calling, transport, and storage experiences of the hunter. These mechanical and performance benefits include one or more, and in certain embodiments all, of the following: being adjustable to multiple lengths and/or bell air outlet diameter, for changing the produced sounds; having a resonance chamber “bell” for improved and forceful sound; being adaptable for use with various reed, diaphragm, or other sound-modulating members/mouthpieces; being usable even with the unaided human voice calling into the bugle tube; collapsible; being lightweight; being portable; and/or being modular so that any of the bugle tube parts, including tube portions and endcap, may be switched for similar portions/parts that are modified in material(s) or in certain embodiments modified in dimensions, or other features or design elements, to meet the challenge of various hunting tasks, environments, desired calling sounds, or personal preference.

In certain embodiments, said modularity provides for one or more of the bugle tube parts to be made of materials, for example, various polymers, acrylic, resins, and/or nylons, that make little or no sound during adjustment of the bugle tube, use, or transport, for example when the bugle hits or brushes past objects, trees, or shrubs. However, in certain embodiments said modularity provides for one or more of the bugle tube parts to be made of materials, for example, aluminum or other metals, which may be more prone to making sound during adjustment, use, or transport. It should be noted that, even when metal or other materials prone to making sound during adjustment, transport, and/or use, are in the bugle tube, the preferred bugle tube comprises adaptations for securement/connection of its parts together in ways that limits the parts hitting or clicking together when the bugle is moved. In certain embodiments, said adaptations are the connections between the tube portions when tube portions are extended, and the connections to the endcap when the tube portions are collapsed.

For example, preferred embodiments of the call comprise one or more of the following key features:
A) Collapsible Design: The bugle tube elk call is designed to be collapsible, allowing hunters to transform it into a smaller, more manageable size for transportation and storage.
B) Telescopic/Sliding Tubes: The bugle tube elk call comprises telescopic tubes that can slide into one another, offering adjustability in length to produce different elk sounds.
C) Portable and Lightweight: The elk call is constructed from lightweight materials, making it easy to carry during long hunting trips without adding unnecessary weight to the hunter's gear.
D) Added or Alternative Sound Modulators/Mouthpieces: The bugle tube may be used with reed, diaphragm, or other sound-modifying elements to supplement the human voice and enhance the sounds emitted from the bugle tube. For example, the bugle tube may be used by a hunter using a conventional in-mouth diaphragm elk call or the bugle tube mouthpiece shown in the drawings may be modified or replaced to comprise a reed or diaphragm or elastic band, for example. Such modulators/mouthpieces may allow hunters to modify the pitch and tone of the elk calls according to their preferences and the specific hunting situation.
E) Easy Assembly: The collapsible bugle tube elk call can be easily assembled and disassembled, making it user-friendly for hunters of all experience levels and making the mouthpiece and/or other tube portions, and the endcap, easy to change-out when desired as further described in section F below.
F) Modularity for Easy Incorporation of Alternative Parts/Tube Portions: The modularity of the preferred bugle tube provides for exchanging one or more of the parts, including tube portions and endcap, for parts of different materials, embellishments, logos, and/or baffles, or even different diameters or shapes as long as the different diameters or shapes still provide proper extension, retraction, and other desired functions as described herein.
G) An endcap of the bugle tube creates a partial seal across the distal end of the bugle tube's interior air passageway, thus, creating a specially designed resonator chamber, enhancing the elk call's acoustic performance and ensuring accurate sound projection.
H) Sound Enhancements: The bugle tube elk call may be made of sound-enhancing materials, for example, chosen for a particular user or desired sound effect, such as various polymers, carbon fibers, resins, acrylic, nylons, and/or aluminum or other metals The various components of the bugle tube may, in certain embodiments, may be made of different materials, and/or components of different materials may be offered as modular replacements for customization. Certain embodiments may comprise baffles to create realistic elk calls that attract elk effectively and improved resonance for generating realistic elk sounds. Any baffles that are added to the central portion or the bell portion should not extend so far toward the central axis of the respective tube portion that the baffles interfere with the extending and collapsing of the tube portions.

Therefore, in certain embodiments comprising multiple or all of the telescoping bugle length-adjustment system, options for various sound-enhancing materials, the end-capped “resonator bell”, and the adaptations for use of, or change-out to, various mouthpieces, the user is enabled to produce various realistic elk vocalizations, such as bugles, grunts, and chuckles, for increased versatility in adapting and using the call for different hunting scenarios and elk vocalizations. The inventors have determined that the bugle tube may be operated to supply loud, clear, and crisp calls of rich resonant sound that will captivate both bull and cow elk and that the collapsable design and light-weight materials provide real benefits for convenient transport and storage on hunting expeditions.

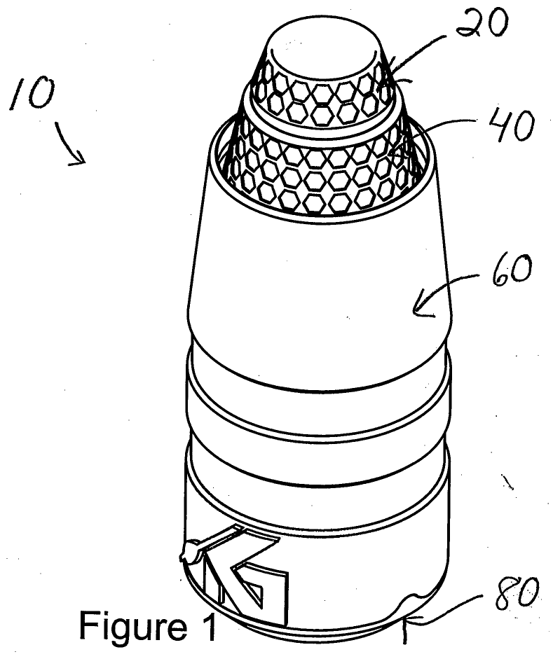

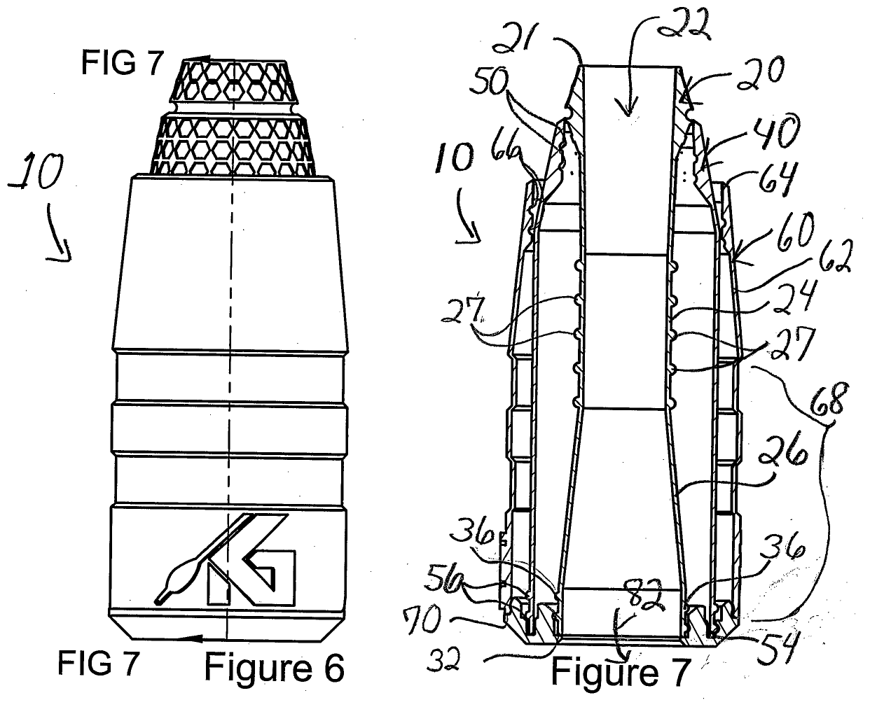

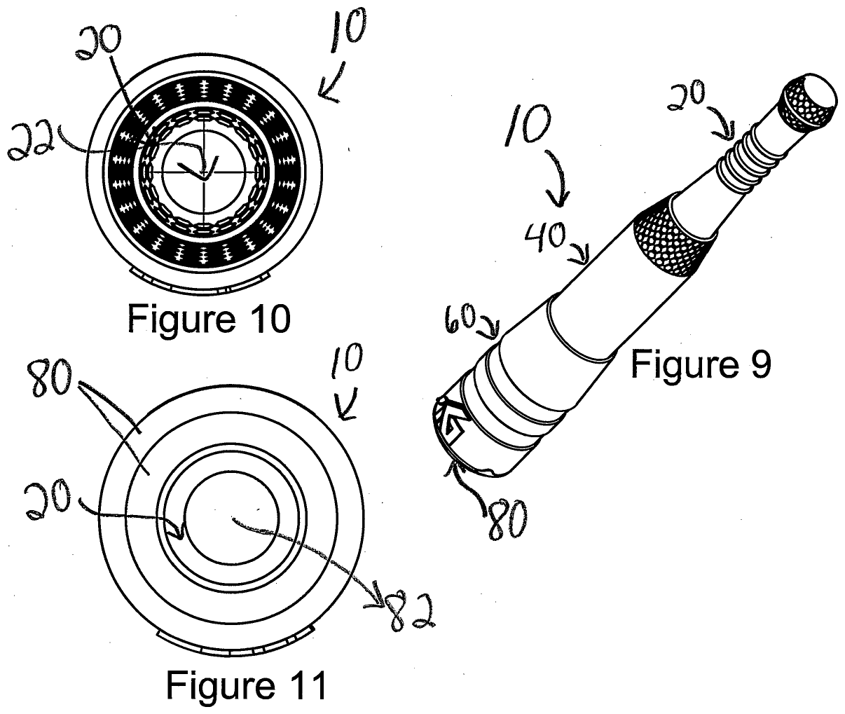

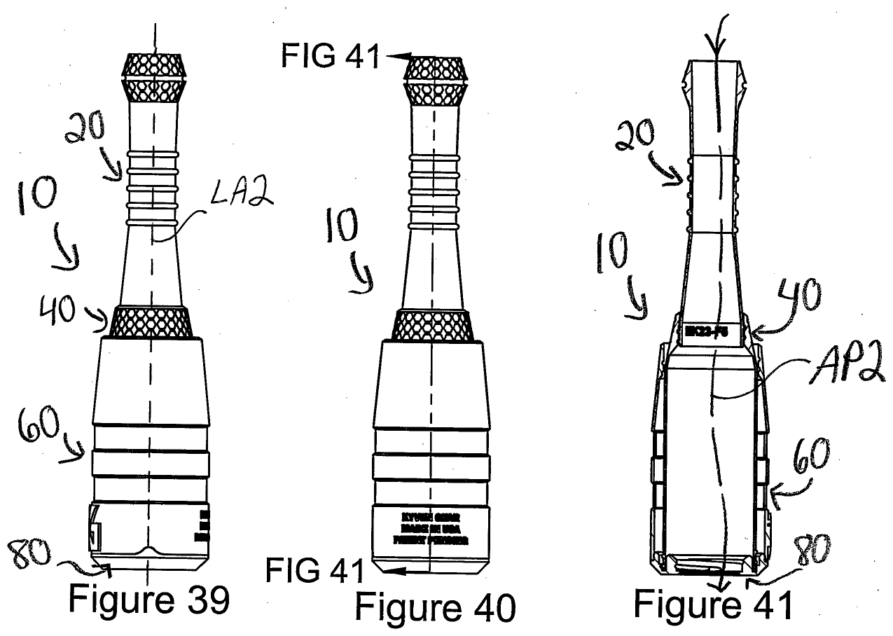

As further described below in detail, certain embodiments of the bugle tube comprise three hollow tubular portions and a multi-purpose endcap. The bugle tube may be configured as a compact, collapsed unit, for example, a generally cylindrical unit for transport or storage (hence, the “transport configuration”) with dimensions in the ranges of 7-10 inches tall and 3-4 inches in diameter, for example. See FIGS. 1-8. The bugle tube may be transformed from the transport configuration to multiple in-use configurations, for example, a fully extended configuration (FIGS. 9-14) or a partially extended (or “mid-point”) configuration (FIGS. 39-41).

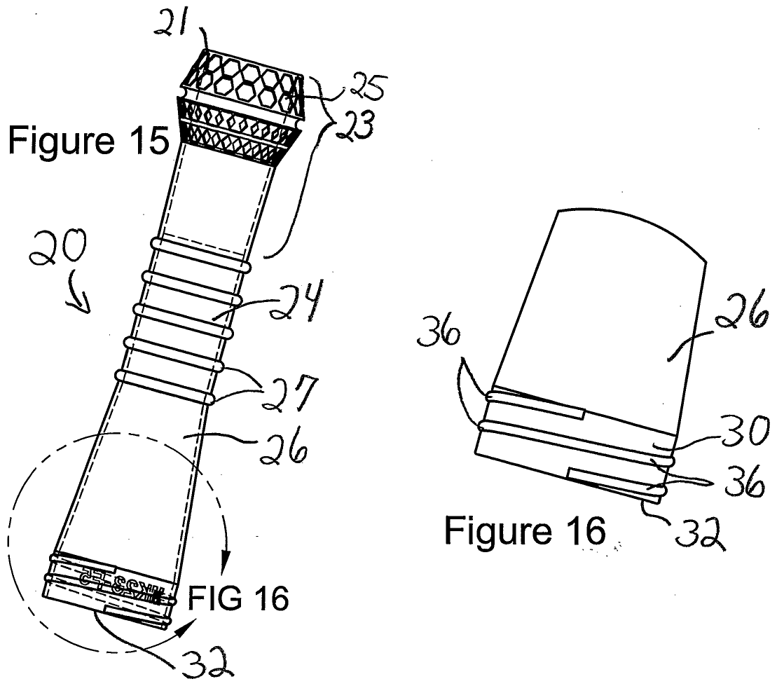

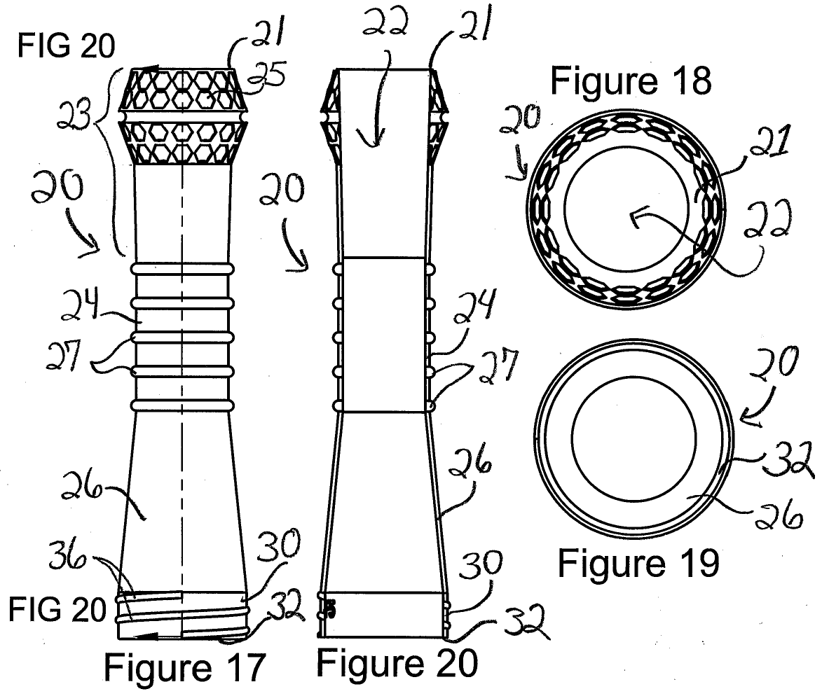

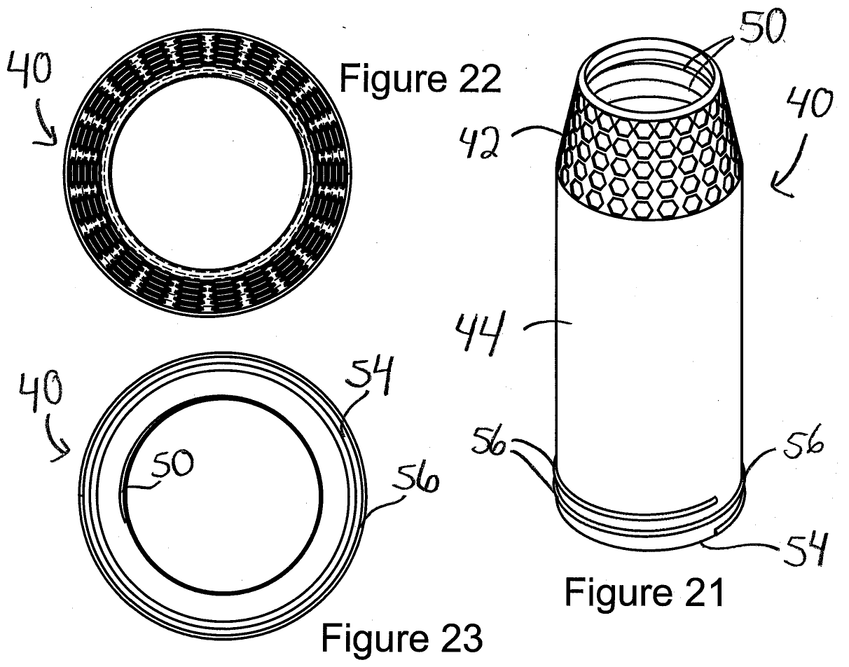

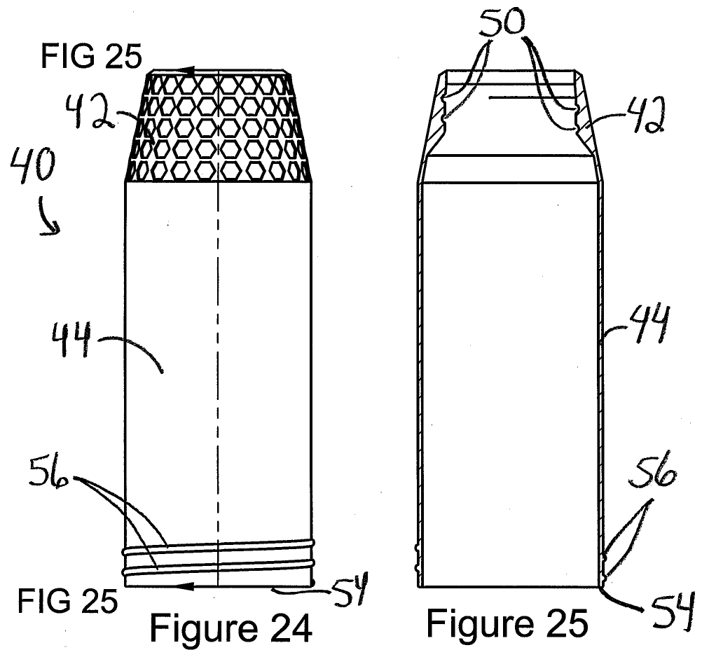

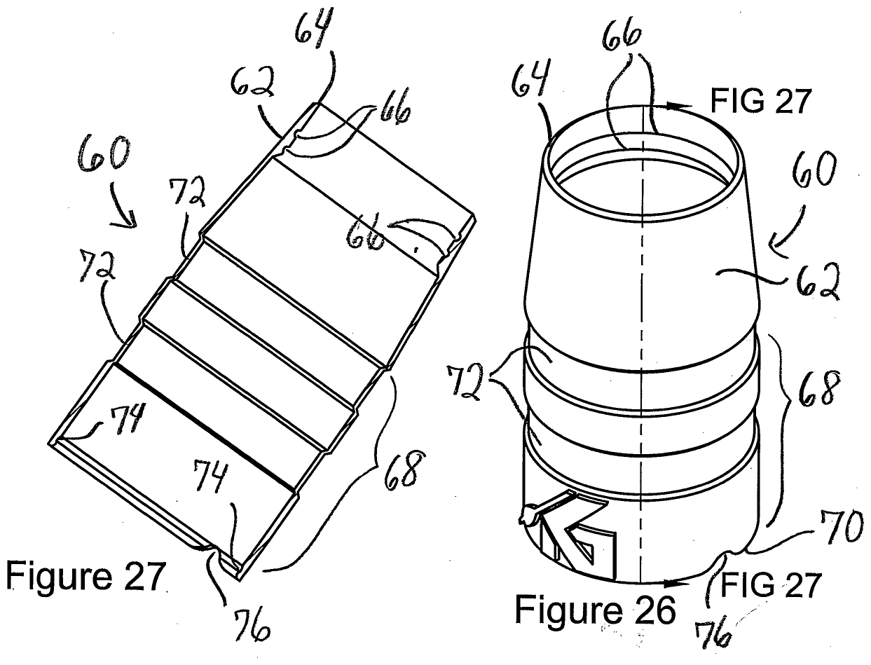

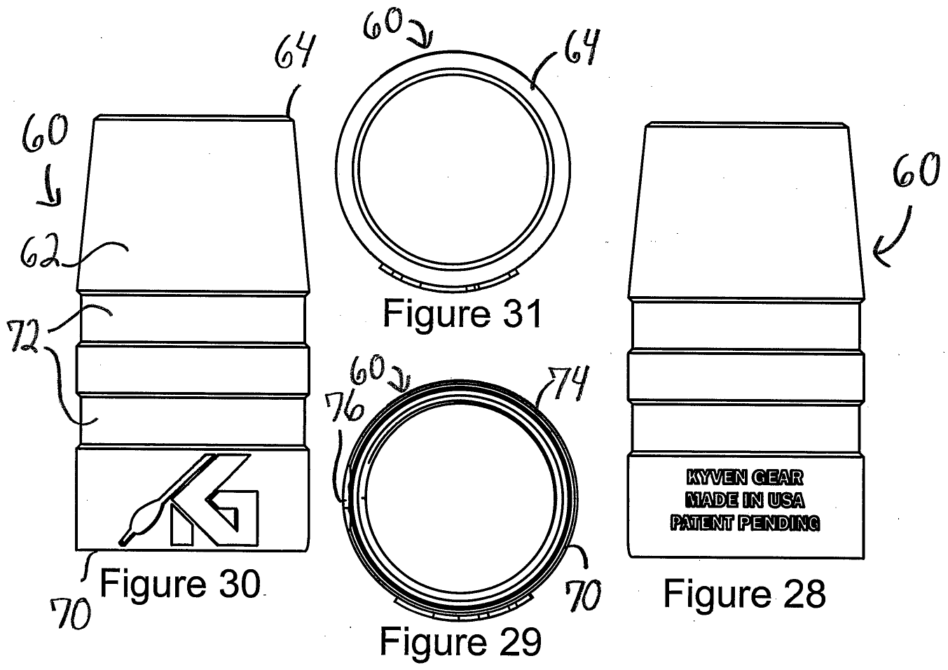

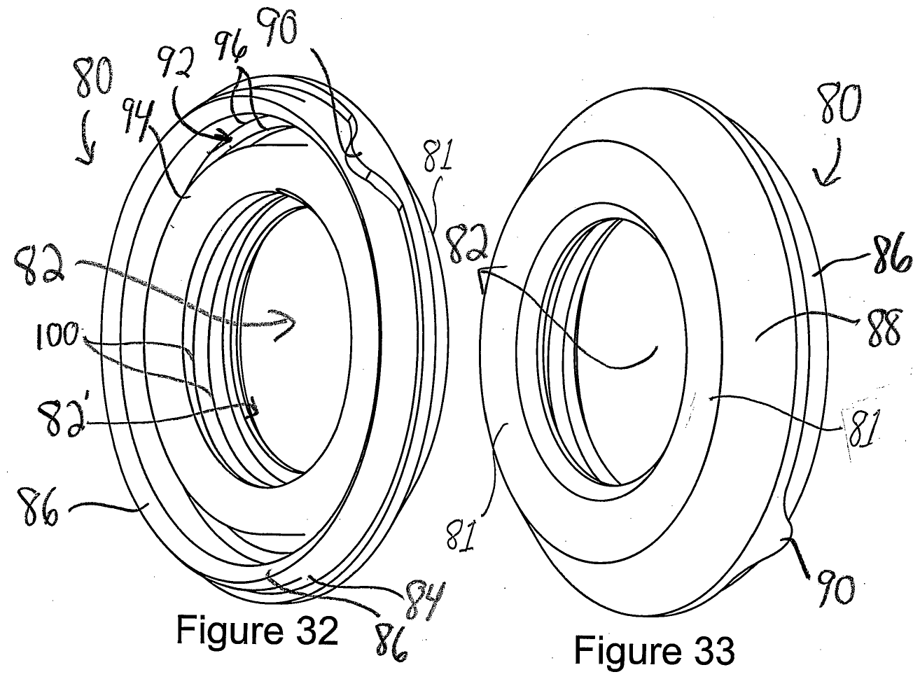

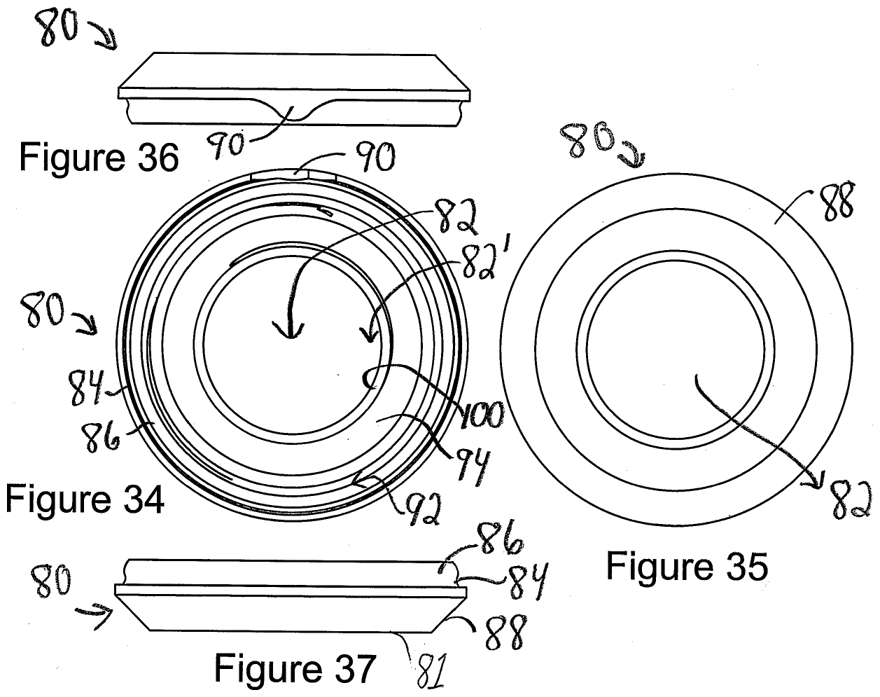

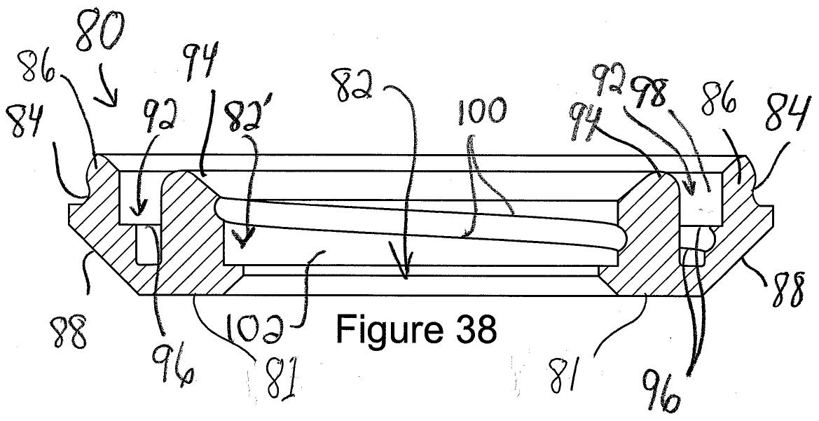

The preferred bugle tube comprises a mouthpiece tube portion (FIGS. 15-20), a central or “main body” tube portion (FIGS. 21-25), an outer shell or “bell” tube portion (FIGS. 26-31), and an endcap (FIGS. 32-38). For simplicity hereafter, the mouthpiece tube portion will typically be called “the mouthpiece”, the central/main body tube portion will typically be called the “central portion”, and the bell tube portion will typically be called the “bell”.

The mouthpiece shown in the figures is designed for comfort when the mouth/lips are pressed against its proximal end, for good air flow by means of a large proximal opening into the bugle tube's interior air passageway, and a gripping surface for easy handling. The central portion may be described as serving as the melodic core of the bugle tube, in that it is designed to amplify and refine the sound produced by the mouthpiece. The cylindrical revolved tube construction of the central portion is substantially larger in diameter than with the mouthpiece, and, in many embodiments, has a smooth, unbaffled and unobstructed interior cylindrical surface, thus allowing for substantially or entirely unrestricted seamless airflow, resulting in a smooth and vibrant tone.

The lower and outermost tube portion of the bugle tube is crafted especially with durability in mind, as this section provides reliable protection for the inner components when the bugle tube is collapsed into its transport configuration, ensuring the longevity of the bugle. In most embodiments, the bell portion is the largest diameter tube section, and serves to amplify the bugle tube sound. Further, being the largest diameter of the tube portions allows the bell portion to serve as a case or cover for the other tube portions in the transport configuration. Both the central portion and the mouthpiece telescope or “collapse” into the bell to be retained inside, and substantially or entirely covered by, the bell, for safe transport and storage; thus, the outer shell/bell may also be called a “case” or “cover”. In the transport configuration, the collapsed bugle tube may be of a size and dimensions that fits into a compact and convenient carrier, such as a pack pocket, a hanger on a user's belt, or in a water bottle carrier such as may be known as a “NALGENE™ bottle carrier”.

To assemble the separate bugle tube parts into the collapsed transport configuration (FIGS. 1-8), the tube portions are all stacked over each other on top of the endcap, as will be understood from their relative diameters and tapered outer surfaces. One easy way to do this is to: a) set the mouthpiece upright on the end-cap and screw the bottom, external threads (also external “coil” hereafter, as the standard CAD term “coil” is used herein interchangeably with “threads” or “threading”) of the mouthpiece into the end-cap (rotating the mouthpiece clockwise into the end-cap, from the perspective of looking down at the mouthpiece and the end-cap), b) set the central portion down over the mouthpiece and screw the bottom external coil of the central portion into the end-cap (rotating the central portion clockwise into the end-cap, from the perspective of looking down at the central portion and end-cap), and then c) set the bell portion down over the stack of mouthpiece-plus-central-portion and engage the bell with the end-cap. The bell may engage/connect to the endcap by a snap-fit in the preferred embodiments but may also or instead use a friction-fit, threading, or other lock, latch, or other connection in certain embodiments. This way, the three tube portions and the endcap are secured/connected together to form the collapsed, “nested” transport unit, which is easy to carry and store. Also, the transport is quiet to carry due to all the bugle tube parts being secured/connected together so that they are not prone to rattle or scrap against each other.

To transform the bugle tube from the transport configuration to an in-use configuration, the mouthpiece and the central portion are unscrewed from the endcap (opposite direction from the paragraph immediately above) and pulled up/outward to telescope them away from the endcap and bell portion. See this fully extended, in-use configuration in FIGS. 9-14, which, in certain embodiments, will be in the range of 20-25 inches long, with a minimum outer diameter of 1.25-1.75 inches at the mouthpiece and a maximum outer diameter of 3.25-4.75 inches at the bell, for example. In certain embodiments, the interior air passageway through the bugle tube, in this fully extended configuration, will range from a minimum of 1-1.5 inches inner diameter in the mouthpiece to a maximum of 3-4.5 inches inner diameter in the bell, for example.

To latch/lock the tube portions together for in-use configurations, the bugle tube comprises a system for latching/locking the tube portions together in one or more extended positions. In certain embodiments, the latching/locking system comprises a threaded system that the inventors call the “KYVEN COIL™” or “TWIST-LOCK™” technology.

In the preferred system, each tube portion has one or more threaded surfaces so that it may threadably connect to at least one other of the tubular portions. In the preferred embodiment shown in the Drawings: the mouthpiece tube portion outer surface lower end comprises thread(s) (the same threads that connect to the end-cap, above); the central tube portion inner surface upper end comprises thread(s) for cooperating with the thread(s) of the mouthpiece portion and the central portion outer surface lower end also comprises thread(s) (the same threads that connect to the end-cap, above); and the bell inner surface upper end comprises thread(s) for cooperating with the central portion lower end thread(s). Both “threads” and “coil” are used herein, with the described and drawn threaded/coiled surfaces providing especially smooth and convenient connectability, secure and quiet connection until the user wishes to detach the parts, and then smooth and convenient disconnectability.

The threads/coils are all orientated so that that act of twisting to latch/lock the central portion to the bell portion, and the act of twisting of the mouthpiece relative to the central portion, may be done with the user's two hands moving in the same directions for each of the two acts. Thus, the transformation to the fully extended configuration may be done by an efficient technique of: a) unscrewing both the mouthpiece and the central portion from the end-cap and telescoped both mouthpiece and central portions upward/outward relative to each other and relative to the bell; and b) grasping only the mouthpiece and the bell and rotating them in opposite directions, thus tightening both the mouth-piece to central portion connection and also the central portion to the bell connection at the same time. For the threading/coil directions shown in the Figures, transforming to the fully extended in-use configuration comprises, rotation of the central portion counterclockwise relative to the bell (from the perspective of looking down on the bugle tube), and rotation of the mouthpiece counterclockwise relative to the bell (also, looking down at the mouthpiece and bell). Rotating the tube portions in the opposite relative directions will undo the twisting latches/locks to disassemble the bugle tube. Alternatively, the threads/coils may be formed during manufacture in the opposite direction, as desired for certain embodiments or users.

As all the hollow tubular portions are open-ended, their open ends are all in fluid communication when in the fully extended in-use configuration, to form an interior air passageway (AP1 in FIG. 14). For example, the mouthpiece is blown into, and that air passes through the mouthpiece, the central body, and the main body/bell, and then out the bottom outlet opening of the end-cap.

Depending on the hunter's preference and the hunting situation, an alternative in-use configuration may be desired to produce higher pitch sounds, for example, the partially extended bugle tube shown in FIGS. 39-41. To transform the bugle tube from the transport configuration to the partially extended configuration, only the mouthpiece is unscrewed from the end-cap, lifted upward/outward relative to the rest of the pieces (central portion, bell, and end-cap), and rotated counterclockwise relative to the central portion (looking down on the bugle tube), to tighten the lower end of the mouthpiece to the top end of the central portion. In this scenario, the central portion is left in place threadably connected to the end-cap, so the rotation to tighten the mouthpiece to the upper end thread/coil of the central portion may be done by the user grasping the end-cap (or the bell that is still connected to the end-cap) in one hand, and the mouthpiece in the other hand, and rotating the mouthpiece relative to the end-cap and bell.

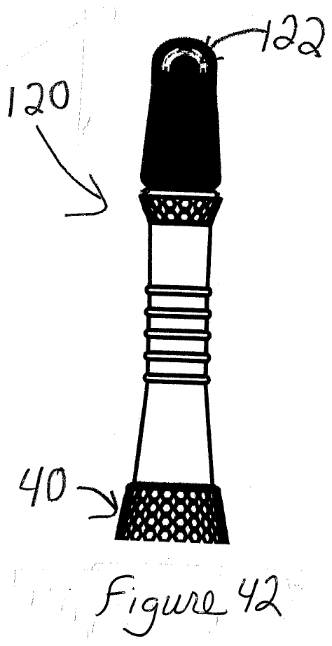

The partially extended in-use configuration, in certain embodiments, is in the range of 14-16 inches long, with a minimum outer diameter of 1.25-1.75 inches at the mouthpiece and a maximum outer diameter of 3.25-4.75 inches at the bell, for example, wherein the bell does not serve here as part of the air passageway (AP2 in FIG. 41). In this configuration, the interior air passageway through the bugle tube comprises only the interior passageways of the mouthpiece and the central portion, but not the bell. In certain embodiments of this partially extended configuration, therefore, the interior air passageway through the bugle tube will range from a minimum of 1-1.5 inches inner diameter in the mouthpiece to a maximum of 2.5-2.75 inches inner diameter in the central portion, for example. In other words, in this partially extended configuration, the interior air passageway AP2 comprises the hollow interiors of the mouthpiece and the central portion, and the bottom outlet opening 82 in the endcap, as the air will flow directly from the central portion out the end-cap instead of exiting the outer shell/bell. Also, in this configuration, not only are the bugle tube and its air passageway shorter, but the maximum diameter of the air passageway is smaller, thus creating additional differences in the bugle tube sound.

In certain embodiments the threads/coil for the latch/lock system extend about two rotations (720 degrees) on their respective tube portion surfaces, so the user may quickly assemble the bugle tube portions with a quick rotation of the tubes. Likewise, disassembly by rotation in the opposite relative direction is quick. The threads/coil are tight enough to create secure connections, while allowing quick purposeful disconnection but unlikely accidental disconnection. Additional features for locking threaded connections may be employed in the certain embodiments of the bugle tube if desired. The threaded connections portrayed in the Figures are extensive and tight enough, in most embodiments, to make a generally, or substantially, air-tight seal between the tube portions, for generally/substantially controlling air flow through the bugle tube and maximizing volume out of the distal/bell end of the bugle tube. Therefore, in many embodiments, a complete/total air-tight-seal between the tube portions is not required, in which cases no separate gaskets or seals are added to the bugle tube. For embodiments where a complete/total air-tight-seal is desired, gasketing or other sealing materials may be added to the bugle tube portions, but preferably not gaskets or seals that would interfere with quick and easy assembly or disassembly.

### Referring Specifically to the Figures and Reference Numbers:

Bugle tube 10 comprises three tube portions, which are mouthpiece 20 with a mouthpiece end 21 (the proximal end of the bugle tube) having top inlet opening 22, main central portion 40 (or “main body”), and outer shell or “bell” 60, and an endcap 80 with a bugle tube bottom outlet opening 82. The three tube portions are adapted to form a tubular unit, the portions having different and varying interior and exterior diameters, so that the mouth-piece end of the tubular unit is the tube portion that is smallest in diameter, the bell end of the tubular unit is the largest in diameter, and the central portion is intermediate in diameter. The tube portions may be embossed, indented, or otherwise provided with texture or patterns on their exteriors to provide a good grip for transforming the bugle tube between the transport and in-use configurations.

### Mouthpiece Tube Portion:

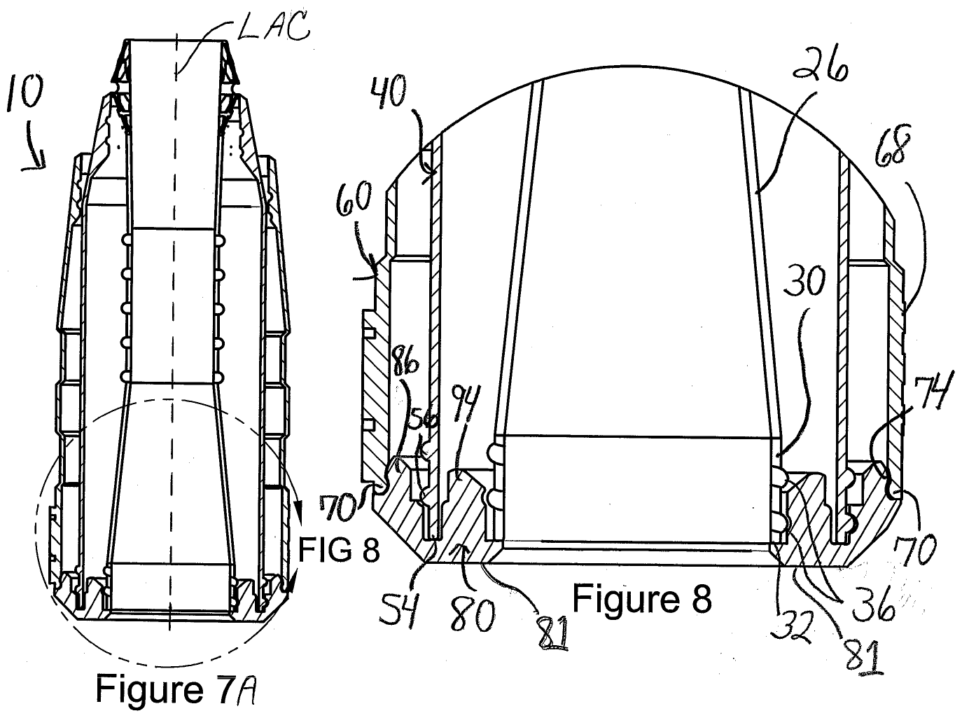

The mouthpiece tube portion 20 of the bugle tube 10 may be described as a four-section cylindrical revolved tube (using the standard CAD term “revolved”). The multiple sections are preferably integrally molded or otherwise formed into the unitary mouthpiece portion 20, which is shown to best advantage in FIGS. 7 and 15-20 and which is further described as follows:
1. The first mouthpiece section 23 provides mouthpiece end 21 where the user's mouth is placed to start the calling sequence and the top air inlet opening 22. This piece uses a fillet feature that rounds the edge approximately 0.4 inches. The inside diameter of the fillet is 1.25 inches. The length of the first section is 2.89 inches, the thickness is 0.13 inches. It is angled (flared) out at 91.5 degrees. At the opposite end of the fillet, it transitions into the second cylindrical feature. The diameter where the mouthpiece transitions is 1.102 inches.
2. The second section of mouthpiece 20 is considered grip section 24, where the user's hand may be placed to hold the bugle tube during the calling sequence. This section 24 is between, and connects, mouthpiece section 23, in item 1 above, and the expansion chamber 26 in item 3 below. This entire revolved grip section 24 is 2.099 inches in length, the thickness is 0.13 inches. The grip surface is integrated into the outer surface of grip section 24, in the form of five revolved arches 27 that have a radius of 0.08 inches. The first arch may be described as being at the transition of mouthpiece section 23 to the grip section 24. The fifth arch may be described as ending at the transition from the grip section 24 to the expansion chamber 26, described below. Each is separated by a distance of 0.51 inches, which is measured by the distance between the center of each arch.
3. The third section of the mouthpiece tube portion 20 is considered the expansion chamber 26. It has an overall length of 2.49 inches, with a thickness of 0.13 inches. The entire expansion chamber 26 is revolved. This connects the grip section 24 to the threaded section or “coil section” 30 described below (also called the “KYVEN COIL™”) that comprises coil 36. The expansion chamber 26 is angled outward as it transitions into the coil section 30, providing a larger diameter at the bottom end 32 (also, “distal end”) of the mouthpiece portion 20. The angle is approximately 87.3 degrees.
4. Coil section 30 of the mouthpiece acts as the connection to the central tube portion 40. This revolved coil section 30 is straight and approximately 1 inch in length and has a thickness of 0.13 inches. This section starts at the transition from the expansion chamber 26 and extends approximately 1 inch to the bottom end 32 of the mouthpiece tube portion 20. The coil section 30 is integrated with a revolution and height coil feature 36, protruding out from the outer surface of the coil section 30. Coil 36 is approximately 1.6 inches in diameter. The coil 36 in the preferred embodiment of the drawings has two revolutions and a height of 0.9 inches. Coil 36 begins at the transition from the expansion chamber 26 and extends the full length of the coil section 30. The thickness of the coil 36 is 0.1 inches and protrudes only on the outside diameter/surface of the coil section 30.

### Central Tube Portion or “Main Body”:

The central tube portion 40 may be described as a cylindrical revolved tube having the following two sections:
1. The first section 42 of the central tube portion 40 acts as a connection to the mouthpiece coil section 30, and as an expansion chamber that takes the inside of this section 42 from approximately 1.612 inches in diameter at its top end to approximately 2.111 inches in diameter at its bottom end. On the upper end of the interior surface of this section 42, starting near the top lip of the section 42, is threading/coil 50 similar to the coil section 30 described above but formed with female threading to cooperate with the male threading 36 of coil 30. Threading/coil 50 is a combined cut with two revolutions that match up with (“threadably mate with”) the threading/coil 36 of coil section 30. This feature has been offset by −0.01 inches. This allows for the coil to travel. The threading/coil 50 also has a 0.03-inch fillet feature which prevents seizing. As one expands (threads) the tube, the threading/coil 50 is designed to tighten gradually into its fully extended coiling position. This is achievable by a revolve cut feature based on the coil profile. Coil 36 will thread into the revolve cut of threading/coil 50. The coil section 30 will then thread into position mating with coil 50. The coil gap will retain a −0.01 offset until the end of the coil. At the end of the coil, the offset of the gap changes from −0.01 to 0. Meaning the cut offset goes away, this intern will prevent the coil from continuing to thread. This causes the coil to snug fit as the coil is forced past the offset gap. Coil 50 begins at the top edge of the angled section 42, which serves as an angled transition to the grip section 44 discussed below. This transition allows for the inner diameter of section 42 to go from 1.612 inches to 2.111 inches. The outside diameter of section 42 starts at 1.817 inches and angles to 2.371 inches.
2. The second section 44 of the central portion 40 is considered the central portion grip, where the user's hand may be placed, if desired, during the calling sequence when the bugle tube is in the fully extended configuration. This entire revolved section 44 is six inches in length, the thickness is 0.13 inches. Section 44 extends from section 42 and ends at the distalmost edge 54 of the central portion 40. The lower approximate 1 inch of section 44 comprises a revolution and height coil feature 56 protruding out of section 44 near the distalmost edge 54 of central portion 40. Coil 56 runs a length of 0.95 inches to reach near the edge 54. Coil 56 has two revolutions. The thickness of the coil is 0.1 inches and protrudes only on the outside diameter.

### The Outer Shell or “Bell”:

The outer shell/bell tube portion 60 may be described as a cylindrical revolved tube having the following two sections:
1. The first section 62 of the outer shell 60 comprises upper edge/lip 64 and an upper threading/coil 66 or (“KYVEN COIL™”) on the interior surface beginning close the edge/lip 64. Section 62 also acts as an expansion chamber, taking the inside of section 62 from approximately 2.391 inches in diameter at the edge/lip 64 to 2.836 inches in diameter. Coil 66 is a combined cut with 2 revolutions that match up and threadably mate with coil 56 of the central portion 40. This coil 66 feature has been offset by −0.01 inches. This allows for the coil to travel. The coil also has a 0.03-inch fillet feature which prevents seizing. As you expand (thread) the tube, the coil is designed to tighten gradually into its fully extended calling position. This is achievable by a revolve cut feature based on the coil profile. Thus, coil 56 will thread into the revolve cut of coil 66. The coil will then thread into position. The coil gap will retain a −0.01 offset until the end of the coil. At the end of the coil, the offset of the gap changes from −0.01 to 0. Meaning the cut offset goes away, this in-tern will prevent the coil from continuing to thread. This causes the coil to snug fit as the coil is forced past the offset gap. The coil begins at the upper edge of the angled transition represented by section 62, which allows for the inner diameter to go from 2.391 inches to 2.836 inches. The outer diameter of section 62 starts at 2.66 inches and angles to 3.10 inches.
2. Section 68 of the bell 60 may be held in the user's hand, or a second hand, during the calling sequence. This revolved section 68 is 3.83 inches in length and has a diameter of 3.10, the thickness is 0.13 inches. Section 68 begins at section 62 and extends to the distalmost edge 70 of the bell and comprises an integrated grip. The grip comprises two revolved indented arches 72 that encircle section 68 and that provide grip indents in the outer surface of section 68 and corresponding protrusions from the interior surface of section 68. The protrusions inside section 68 may be described as baffles inside the outer shell, disrupting the airflow and thereby enhancing sound quality. The indents 72 and corresponding protrusions also enhance the structural integrity of the bell portion 60 and the bugle tube 10. Near and just inside from the distalmost edge 70 of the lower end of the bell 60 is an internal snap-fit lip 74. See FIGS. 8 and 27. The lip 74 is 0.132 inches long and has a radius of 0.079 inches. The lip 74 brings the thickness of the lower wall of the bell 60 from 0.13 inches to 0.158. The snap-fit feature 74 enables the connection of the bell 60 to the endcap 80. In addition, the lower end of the bell 60 has a guided triangular fitment feature 76 that cooperates with a mating structure on the endcap, to allow the endcap to only snap onto the bell 60 in one orientation and to contribute to preventing the endcap from rotating relative to the bell 60.

### The Endcap of the Bugle Tube:

The preferred endcap 80 comprises a radial wall 81 having an aperture that serves as the bottom air outlet opening 82 for the bugle tube 10, and features that allow the rest of the bugle tube to securely fasten into one assembly. This endcap radial wall partially closes the bottom end of the bugle tube, which, combined with the specially adapted outer and inner diameters of the tube portions, prevents the tube portions from falling apart. The endcap blocks the central portion 40 and mouthpiece 20, whether or not central portion 40 and mouthpiece 20 are latched/locked to each other, from falling down out of the bell 60. Further, each tube portion preferably has a larger bottom outer diameter compared to its top outer diameter, and the bottom outer diameter of the central portion 40 is larger than the top inner diameter of the bell 60, and the bottom outer diameter of the mouthpiece 20 is larger than the top inner diameter of the central portion 40. Thus, when the central portion is disconnected from the bell, and the central portion and mouthpiece are disconnected from the endcap, and/or the endcap is removed from the assembly, said diameter relationships prevent the mouthpiece 20 from sliding up out of the central portion 40 and prevent the central portion 40 from sliding up out of the bell, whether or not the central portion 20 and mouthpiece are latched/locked together. However, with the endcap removed and the portions 20 and 40 are disconnected from each other and portion 40 is disconnected from the bell 60, the tube portions 20, 40 and 60 may all fall apart from each other, for example, portions 20 and 40 can fall out the bottom of portion 60 and also fall apart from each other. These results point out that, in certain embodiments, there is no friction fit or grip between the mouthpiece portion 20, central portion 40 and the bell portion 60, unless and until the twist-lock or other securement is engaged between these tube portions.

In certain embodiments, key features contribute to keeping the endcap in place on the bell 60 and in forming and maintaining the compact travel and storage unit wherein the tube portions are nested together and do not fall apart from each other or rattle during transport. These features of the preferred embodiment shown in the Figures may be described as follows:
1. The outer surface 84 of the “outer rim” 86 of the endcap 80 connects the bell 60 to the endcap 80. Outer surface 84 is recessed to receive the snap-fit lip 74 of the bell 60, in a fit sufficiently tight to hold the bell 60 on the endcap 80. This feature has a radius of 0.146 inches and creates a snug fit for the lip 74. Above the snap fit recess (84) is a filet feature that allows lip 74 to slide into the end-cap. This deburrs this feature and prevents it from galling. The total outside diameter of the endcap is 3.10 inches. The endcap 80 has a chamfer feature 88 that curves downward toward the distal end of the end-cap. The endcap has a guided triangular fitment feature 90 that cooperates with a corresponding recessed feature 76 on the distalmost edge 70 of the bell. This “indexes” the endcap 80 and the bell 60, allowing the endcap 80 to only snap onto the bell 60 in one way, and, in certain embodiments, helps prevent rotation of the end-cap relative to the bell.
2. The space 92 between the outer rim 86 and the middle rim 94, formed in part by the threads 96 of inner surface 98 of the outer rim 86, connect the endcap 80 to the lower end of the central portion 40. The threading/coil 56 that is embossed onto the lower outer surface of section 44 of the central portion 40 threadably engages and mates with the threaded (96) inner surface 98 of the outer rim 86, with the distalmost edge 54 of the central portion 40 entering the space 92. In other words, a coil feature (threads 96) that is matched to coil 56 is cut into the middle of the endcap, where they can thread into a snug fitment. This end-cap coil feature 96 has approximately 1½ revolutions, that is, fewer than the coil 56.
3. Threading/coil 100 of the center wall 102 of the endcap connects the endcap to the coil section 30 of the mouthpiece 20. Coil 36 of coil section 30 threadably connect/mate to the center threads 100 of wall 102 as the bottom end 32 of the mouthpiece 20 enters the bottom outlet opening 82′, wherein space 82′ is the area of opening 82 near wall 102 of the endcap 80. The matched threads of coil 100 are cut into the center wall 102 of the endcap where they can thread into a snug fitment. This coil 100 has approximately 2 revolutions, that is, about the same as coil 36.
4. Therefore, with the central portion 40 and mouthpiece 20 nested together, their lower ends coils (56 and 36, respectively) may thread into space 92 and space 82′, respectively. Thus, the central portion 40 and mouthpiece 20 are connected to the endcap in concentric spaces 92 and 82′ so that they are concentric to each other. The coil gap will retain a −0.01 offset until the end of the coil. At the end of each coil, the offset of the gap changes from −0.01 to 0. Meaning the cut offset goes away, this intern will prevent the coil from continuing to thread. This causes the coil to snug fit as the coil is forced past the offset gap.

It should be noted that, while the threading/coils of the tube portions described above and shown in the drawings are made with two revolutions, a higher number of revolutions, such as 3 or more, may be desirable in certain embodiments for increased structural integrity and/or for certain materials. Likewise, in certain embodiments where the tube portion coil revolutions are increased, the threading/coils in the endcap also may be increased for further structural integrity.

In many embodiments, the tube portions and the endcap are rigid, for example, rigid polymeric, carbon fiber, resins, acrylic, nylons, and/or aluminum or other metal material. In many embodiments, there is little or no metal, except that an optional diaphragm mouthpiece may have a metal rim supporting the diaphragm, for example; limiting or eliminating metal keeps transport, handling and use of the bugle tube very quiet or silent except for the desired call sounds.

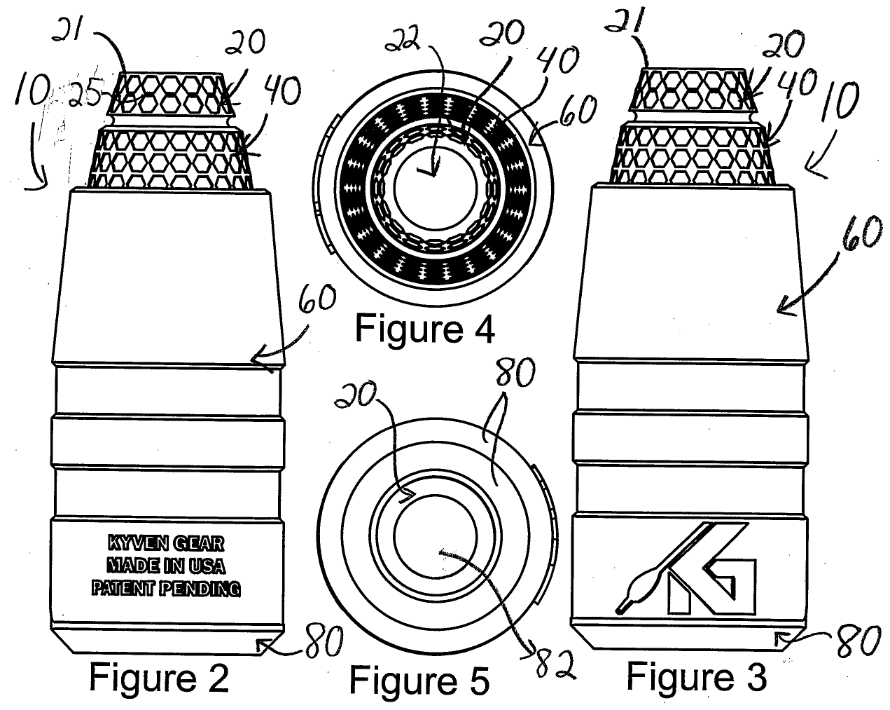

Some hunters may use the bugle tube 10 alone, without any other apparatus such as a reed or diaphragm call. However, most hunters will use bugle tube 10 with a reed elk call or a diaphragm elk call so that the sound from the reed or diaphragm call will enter the bugle tube 10 and be modified and/or at least amplified by the bugle tube 10 in ways that enhance the resulting sound and the chance of a successful hunting experience. Bugle tube 10 may be used in combination with a conventional diaphragm call that is placed entirely inside the mouth as is known in the field. For example, bugle tube 10 may be used effectively and conveniently used with an AMP™ diaphragm call that is available at https://www.phelpsgamecalls.com/. Alternatively, the bugle tube 10 may connect to an alternative mouthpiece provided to supplement or replace mouthpiece 20. Such an alternative may comprise placing a supplemental reed, diaphragm, elastic band, or other sound-modifying member onto the existing mouthpiece 20, for example, by snapping, covering, friction-fitting, or otherwise connecting such a sound-modifying member to the end (21, 25) of the mouthpiece 20. Or mouthpiece end 25 may be adapted to be removable, and such a supplemental sound-modifying member could replace the mouthpiece end-piece 25 (FIGS. 2, 15, and 17) for example by being threadably attached or otherwise connected where the mouthpiece end 25 was removed. One schematic example of a modified replacement mouthpiece 120 is shown in FIG. 42, wherein the mouthpiece is shown connected to, and extending up from, the central portion 40 of bugle tube 10. Mouthpiece 120 will be understood to include a diaphragm call element 122 at its proximal end, but to comprise the other features and operations of mouthpiece 20 as described herein. The distal end including a coil to connect to central portion 40, and the interior, of mouthpiece 120 may be the same or very similar to the distal end of mouthpiece 20 so that the functions and use described in this document and drawings will be the same or very similar. Game call apparatus other than that shown in FIG. 42 may be provided as a modified/substitute mouthpiece, for example other diaphragms, reeds, or elastic bands, consistent with a goal of providing air to the bugle tube 10 to create sounds according to the preferences and skills of the hunter, but enhanced and amplified by the bugle tube 10.

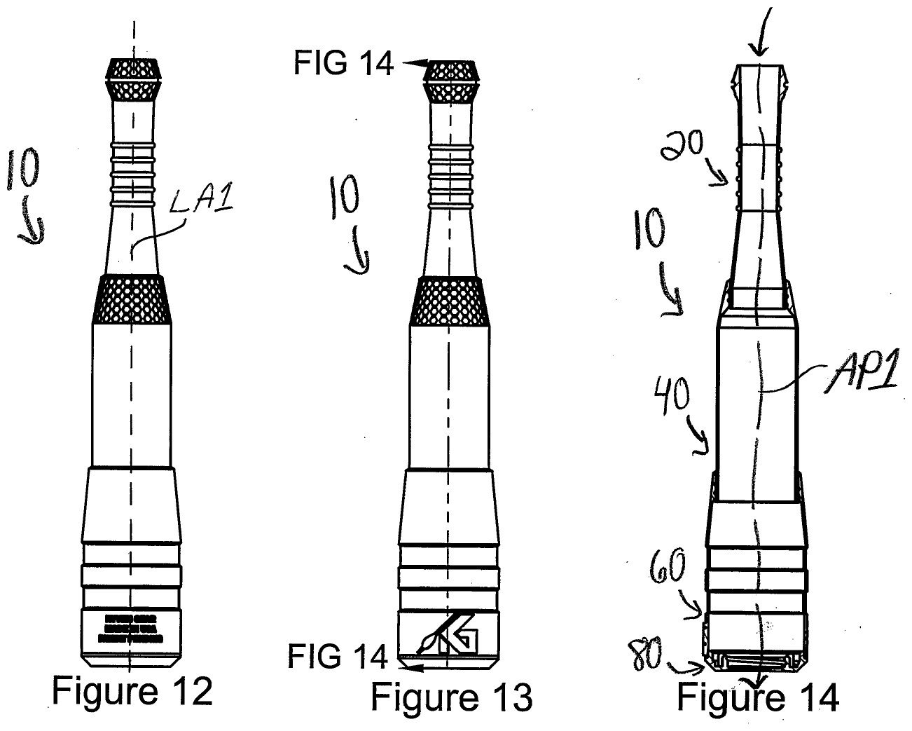

As explained above, the bugle tube may be effective when used in combination with a reed, diaphragm, elastic band, or other mouthpiece that supplements the human voice, and, in certain embodiments, the bugle tube assembly requires no extra equipment or add-ons. However, in certain other embodiments, a flexible tube may be added to the air-outlet of the bugle tube, that is, on or in the endcap or bell portion of the bugle tube. For example, this may allow a hunter to point the sound outlet in a desired direction that may be at an angle to the longitudinal axis of the bugle tube. While such a flexible member may be added to the bugle tube, to customize use of the bugle tube for certain hunters, the bugle tube in most embodiments does not include any pivot, bend, flex, hinge, or other structure adapted for significant movement of any of the tube portions or the endcap, during storage or use, to an angle to the longitudinal axis of the bugle tube. This will be understood from viewing the longitudinal axis LA-C of the bugle tube in the collapsed configuration (FIG. 7A), longitudinal axis LA1 of the fully extended configuration (FIG. 12), and longitudinal axis LA2 of the partially extended configuration (FIG. 39). It may be noted that these longitudinal axes LAC, LA1, or LA2 are the same, as the preferred tubular portions and endcap may be described as cylindrical or conical along their lengths, and are coaxial or substantially coaxial during all their longitudinal sliding for extension, their use, and their longitudinal sliding for retraction.

In summary regarding certain embodiments, the bugle tube for use in game calling comprises multiple tube portions each having a longitudinal axis and an interior passageway, said tube portions being extendible to a first in-use configuration having a first in-use axial length (for example, see FIG. 12) and wherein the interior passageways of the tube portions are in fluid communication to form a bugle air passageway, and said tube portions being collapsible to a transport configuration wherein the multiple tube portions are coaxially nested together, and wherein the transport configuration of the bugle tube has an axial length that is less than half of the first in-use axial length, and in many embodiments, 35-45 percent of the first in-use axial length. The multiple tube portions may be rigid. The multiple tube portions may be threadably connected together in the first in-use configuration. The tube portions may comprise a lower/distal bugle tube portion (that may also be called a “bottom bell tube” or “bell” for its sound producing quality in-use, or “outer shell” for its protective/casing quality in transport/storage) and upper tube portions (or “upper tubes”), and an endcap that may extend part way across a bottom opening of the bell tube to create back-pressure in the bugle tube for creating resonance in sound from the bugle tube during game calling. The endcap may extend across 45-55 percent of the bottom opening, for example. A plurality of the tube portions, when in the transport configuration, may be connected to the endcap in the transport configuration. The plurality of tube portions may be threadably connected to the endcap in the transport configuration, for example. The bugle air passageway in the first in-use configuration preferably comprises the interior passageways of all the upper tube portions including the interior passageway of the bell tube. The tube portions may be extendible to the first in-use configuration by telescoping/sliding longitudinally relative to each other. In certain embodiments, including embodiments wherein the tube portions are extendible to the first in-use configuration, the tube portions may be described as comprising a bottom bell tube, a lowermost upper tube (for example, see central tube portion 40), and at least one additional upper tube (for example, see mouthpiece 20), and may transform to a second in-use configuration wherein the lowermost upper tube is nested inside the bottom bell tube, and the at least one additional upper tube extends up from the lowermost upper tube, wherein said second in-use configuration of the bugle tube has a second in-use axial length (for example, see FIG. 39) that is between the length of the transport configuration and the first in-use configuration. For example, the second in-use configuration axial length may be about 50-90 percent longer than the transport configuration axial length and/or 30-50 percent shorter than the first in-use configuration. The game calling air flowing through the bugle tube interior air passageway in said second in-use configuration may produce a different sound than the game calling air flowing through the bugle tube interior air passageway in the first in-use configuration. The bugle air passageway in the second in-use configuration comprises the interior passageways of the lowermost upper tube and said at least one additional upper tube and does not comprise the interior passageway of the bell tube, as the lowermost upper tube is connected to the endcap in such a way that air from the lowermost upper tube flows directly to the endcap aperture. In said second in-use configuration, the lowermost upper tube is preferably secured to the endcap, for example, by a threaded connection. In the first in-use and the second in-use configurations, the endcap extending part way across a bottom opening of the bell tube creates back-pressure in the bugle tube for creating resonance in sound from the bugle tube during game calling.

As will be understood from this Description and the Figures, in certain embodiments, a bugle tube for game calling may instead be described as comprising: tube portions that telescope between a collapsed configuration for transport and storage, and a fully extended configuration for use in game calling; the tube portions each having a longitudinal axis and the tube portions comprising an outer-bottom tube (or “bottom tube” or “bell tube” or “outer shell”) and upper tubes; wherein, in the collapsed configuration, the upper tubes are nested concentrically inside the bottom tube; wherein the bugle tube further comprises an endcap connected to the bottom tube at a bottom end of the bottom tube, the endcap having a radial wall that extends perpendicularly to the longitudinal axis of the bottom tube, whereby, in the collapsed configuration, said upper tubes are retained above the endcap and prevented by said radial wall from sliding down out of said bottom tube; wherein, in the fully extended configuration, the upper tubes telescope upward to extend up from the bottom tube, each upper tube is threadably connected to at least one other of the upper tubes, and the upper tubes comprise a lowermost upper tube that is further connected to the bottom tube, and the endcap radial wall comprises an aperture that is in fluid communication with interior air passageways of each of the bottom tube and the upper tubes, so game calling sound travels through the entire bugle tube. All of the bottom tube and the upper tubes are preferably rigid. The endcap radial wall preferably extends across 45-55 percent of the bottom tube bottom end, to create back-pressure in the bugle tube for creating resonance sound from the bugle tube during game calling. The upper tubes are preferably further retained in the collapsed configuration by being threadably connected to the endcap. The collapsed configuration has a length, and the fully extended configuration has a length that is more than twice as large as the length of the collapsed configuration. The bugle tube further may have a partially extended configuration for use in game calling, wherein said lowermost upper tube is connected to the endcap and is not telescoped to extend up from the bottom tube portion, so that the lowermost upper tube remains nested inside the bottom tube (or substantially inside the bottom tube, which means the entire lowermost upper tube remains inside the bottom tube except for a small portion, for example, the upper end of central tube 40, about 20 percent of the tube 40 length, such as is shown above the bell 60 in FIGS. 2 and 3), wherein another of the upper tubes is telescoped to extend up above the lowermost upper tube, and the lowermost upper tube and said another of the upper tubes are in fluid communication with the aperture in the endcap and not with the bottom tube portion. In this partially extended configuration, game calling air travels through all the upper tubes and directly to the aperture in the endcap and the game calling air does not pass through the bottom tube portion. The collapsed configuration has a length, and the partially extended configuration has a length that is 50-90 percent greater than the length of the collapsed configuration.

Although the invention has been described herein with reference to particular means, materials, and embodiments, it is to be understood that the invention is not limited to these disclosed particulars but extends instead to all equivalents within the scope of the following claims.

1. A bugle tube for use in game calling, the bugle tube comprising multiple tube portions each having a longitudinal axis and an interior passageway, said tube portions being extendible to a first in-use configuration having a first in-use axial length and wherein the interior passageways of the tube portions are in fluid communication to form a bugle air passageway, and collapsible to a transport configuration wherein the multiple tube portions are coaxially nested together, wherein the transport configuration of the bugle tube has an axial length that is less than half of the first in-use axial length.

2. The bugle tube as in claim 1, wherein the multiple tube portions are rigid.

3. The bugle tube as in claim 2, wherein the multiple tube portions are threadably connected together in the first in-use configuration.

4. The bugle tube as in claim 1, wherein the tube portions comprise a bottom bell tube, and upper tubes, and an endcap extending part way across a bottom opening of the bell tube to create back-pressure in the bugle tube for creating resonance in sound from the bugle tube during game calling.

5. The bugle tube as in claim 4, wherein the endcap extends across 45-55 percent of the bottom opening.

6. The bugle tube as in claim 4, wherein a plurality of the tube portions in the transport configuration are connected to the endcap.

7. The bugle tube as in claim 6, wherein said plurality of tube portions are threadably connected to the endcap in the transport configuration.

8. The bugle tube as in claim 4, wherein the bugle air passageway in the first in-use configuration comprises the interior passageways of all the upper tube portions including the interior passageway of the bell tube.

9. The bugle tube as in claim 1, wherein the tube portions are extendible to the first in-use configuration by telescoping.

10. The bugle tube as in claim 1, wherein the tube portions comprise a bottom bell tube, a lowermost upper tube, and at least one additional upper tube, and, in a second in-use configuration, the lowermost upper tube is nested inside the bottom bell tube, and the at least one additional upper tube extends up from the lowermost upper tube, wherein said second in-use configuration of the bugle tube has a second in-use axial length and that is 50-90 percent longer than the axial length of the transport configuration.

11. The bugle tube as in claim 10, wherein the bugle tube has a bugle air passageway in the second in-use configuration that comprises the interior passageways of the lowermost upper tube and said at least one additional upper tube and does not comprise the interior passageway of the bell tube.

12. The bugle tube as in claim 11 further comprising an endcap extending part way across a bottom opening of the bell tube to create back-pressure in the bugle tube for creating resonance in sound from the bugle tube during game calling.

13. The bugle tube as in claim 12, wherein the endcap extends across 45-55 percent of the bottom opening.

14. The bugle tube as in claim 12, wherein, in said second in-use configuration, the lowermost upper tube is secured to the endcap.

15. The bugle tube as in claim 14, wherein, in said second in-use configuration, the lowermost upper tube is threadably connected to the endcap.

16. A bugle tube for use in game calling, the bugle tube comprising:
tube portions that telescope between a collapsed configuration for transport and storage, and a fully extended configuration for use in game calling;
the tube portions each have a longitudinal axis and the tube portions comprise a bottom tube and upper tubes;
wherein, in the collapsed configuration, the upper tubes are nested concentrically inside the bottom tube;
wherein the bugle tube further comprises an endcap connected to the bottom tube at a bottom end of the bottom tube, the endcap having a radial wall that extends perpendicularly to the longitudinal axis of the bottom tube, whereby, in the collapsed configuration, said upper tubes are retained above the endcap, and prevented by said radial wall from sliding down out of said bottom tube;
wherein, in the fully extended configuration, the upper tubes telescope upward to extend up from the bottom tube, each upper tube is threadably connected to at least one other of the upper tubes, and the upper tubes comprise a lowermost upper tube that is further connected to the bottom tube, and the endcap radial wall comprises an aperture that is in fluid communication with interior air passageways of each of the bottom tube and the upper tubes, so game calling sound travels through the entire bugle tube.

17. The bugle tube as in claim 16, wherein all of the bottom tube and the upper tubes are rigid.

18. The bugle tube as in claim 16, wherein the endcap radial wall extends across 45-55 percent of the bottom tube bottom end, to create back-pressure in the bugle tube for creating resonance sound from the bugle tube during game calling.

19. The bugle call as in claim 16, wherein the upper tubes are further retained in the collapsed configuration by being threadably connected to the endcap.

20. The bugle tube as in claim 16 wherein the collapsed configuration has a length and the fully extended configuration has a length that is more than twice as large as the length of the collapsed configuration, and wherein:
the bugle tube further has a partially extended configuration for use in game calling, wherein said lowermost upper tube is connected to the endcap and is not telescoped to extend up from the bottom tube portion so that the lowermost upper tube remains inside the bottom tube, wherein another of the upper tubes is telescoped to extend up above the lowermost upper tube, and the lowermost upper tube and said another of the upper tubes are in fluid communication with the aperture in the endcap and not with the bottom tube portion, whereby, in the partially extended configuration, game calling air travels through all the upper tubes and directly to the aperture in the endcap and the game calling air does not pass through the bottom tube portion.

21. The bugle call as in claim 20, wherein the collapsed configuration has a length, and the partially extended configuration has a length that is 50-90 percent greater than the length of the collapsed configuration.
